(19) United States
(12) Patent Application Publication
(10) Pub. No.: US 2016/0217506 A1
(43) Pub. Date: Jul. 28, 2016

(54) VEHICLE INVENTORY VERIFICATION SYSTEM, APPARATUS AND METHOD

(71) Applicant: Halcyon Consulting, LLC, Columbia, MD (US)

(72) Inventors: Srinivas Kakarala, Ellicott City, MD (US); Kartikeya Kakarala, Irving, TX (US)

(73) Assignee: Halcyon Consulting, LLC, Columbia, MD (US)

(21) Appl. No.: 15/006,858

(22) Filed: Jan. 26, 2016

Related U.S. Application Data
(60) Provisional application No. 62/107,083, filed on Jan. 23, 2015.

(51) Int. Cl. G06Q 30/02; G07C 5/00; G07C 5/08; G06Q 30/06

(52) U.S. Cl. CPC G06Q 30/0278; G06Q 30/0641; G07C 5/008; G07C 5/08

(57) ABSTRACT

Described herein is a system, method, and devices for remotely updating a purchase price, such as an MSRP, of a vehicle, wherein the vehicle is located in an inventory of vehicles and the price is displayed electronically on a display associated with the vehicle. A system comprises a client device (portable user device); a data center; a dealer server connected to a transmitter; and a plurality of receivers, each receiver comprising an electronic price tag configured with a display, and associated with a vehicle within a vehicle inventory; the system configured for sending a request via the client device to the data, the request comprising a vehicle identifier and a value, the value corresponding to the purchase price of the vehicle, forwarding the value of the request to the transmitter, and updating the price displayed on the electronic price tag to reflect the value of the request.

### CROSS REFERENCE TO RELATED APPLICATIONS

This application claims the benefit of U.S. Provisional Patent Appl. No. 62/107,083 filed on Jan. 23, 2015 the contents of which are hereby incorporated by reference in its entirety.

### FIELD OF INVENTION

The present invention, and various embodiments thereof, relates to remotely updating or retrieving one or both of a vehicle sale price or a status of vehicle diagnostic information.

### BACKGROUND

Currently, there are no methods in place that enable remote updating to vehicle pricing or gathering of vehicle diagnostic information, other than dealer personnel locating a vehicle on a dealer lot and attending to a price update or retrieval of vehicle information manually.

### SUMMARY OF INVENTION

Described herein is a system, method, and devices for remotely updating a purchase price, such as an MSRP, of a vehicle, wherein the vehicle is located in an inventory of vehicles and the price is displayed electronically on a display associated with the vehicle.

In one embodiment, a method for updating a vehicle purchase price electronically displayed in a vehicle, comprises sending a request to update a purchase price electronically displayed in a vehicle, the request comprising a vehicle identifier and a value, wherein the value corresponds to the purchase price of the vehicle—wherein the request is sent from an electronic device in wireless communication with a dealer server; receiving the request at the dealer server; broadcasting the request from a transmitter connected with the dealer server to one or more of a receiver associated with a vehicle; and upon receiving the request by the receiver associated with the vehicle identifier in the request, updating the vehicle purchase price electronically displayed on the display of an electronic tag connected to the receiver.

In one embodiment, a user, such as a car dealership employee, initiates a price update or vehicle status request via a web-based interface on a client device or mobile application on a portable device, for a specific vehicle identified by a pre-determined vehicle identifier. When the update or status request is initiated, the request is sent electronically from the client device to a server connected to a base station/transmitter located at the dealer's location. This transmitter sends a signal out to one or more receivers installed in vehicles among a dealer vehicle inventory. The receiver associated with the vehicle identifier receives the request and causes the price displayed on the display of an electronic tag associated with the vehicle to update with the price contained in the request.

In another embodiment, the receivers communicate with the transmitter with vehicle information comprising, in part, a list of data associated with vehicles and reply back to the transmitted request with the list of data representing vehicle information. The transmitter then sends vehicle information received from the receiver to the server, where the vehicle information is stored and further converted to a tabular or graphical format, and may also be utilized for data analytics.

In accordance with another aspect, there is provided a non-transitory computer-readable medium having recorded thereon a program that causes a portable device to execute a method for updating the price of a vehicle, wherein the price is electronically displayed on the vehicle, comprising sending a request from a user device to a dealer server; processing the request on the server; routing the request from the server to a transmitter connected to the server via hardware or wireless connection; transmitting the request from the transmitter to one or more of a receivers (such as a plurality of receivers) arranged in a network, wherein each receiver is associated with a pre-determined vehicle in a dealership inventory, the network of receivers arranged in a connected network topography; upon receiving the request, communicating the request amongst the receivers until the vehicle matching the request is located; updating the price displayed on the display screen of the electronic price tag associated with the vehicle according to the price contained in the request; and, optionally, responding to the request with a vehicle record associated with the asset, wherein the vehicle record comprises a list of set of data, comprising one or more of a VIN, make, model, price, mileage, geo-location; sending the vehicle record from the receiver to the remote server; and responding from the server to the data center, for further storage and processing by one or more of a data analytics module.

In accordance with another aspect, there is provided a method of remotely updating a sale price of a vehicle, comprises: entering, via a user input on a portable electronic device, a price to be displayed on an electric tag associated with a vehicle in a dealer inventory using input means on the portable electronic device, wherein price is inputted as a numerical value; transmitting the inputted price of the vehicle to a server where a record of the value may be stored; communicating with a transmitter connected to the server and transmitting the updated price from the transmitter connected to the server to a receiver associated with the vehicle in the dealer inventory for which the price is to be updated; receiving the updated price by the receiver associated with the vehicle in the dealer inventory for which the price is to updated; and displaying the price on a display screen associated with and in communication with the receiver.

In accordance with another aspect, there is provided a non-transitory computer-readable medium having recorded thereon a program that causes a portable device to execute a method for remotely updating a sale price of a vehicle, comprises: entering, via a user input on a portable electronic device, a price to be displayed on an electric tag associated with a vehicle in a dealer inventory using input means on the portable electronic device, wherein price is inputted as a numerical value; transmitting the inputted price of the vehicle to a data center, wherein the price is stored on a server of the data center in association with a vehicle record corresponding to the vehicle in the dealer inventory for which the price is being updated; forwarding the updated price to a remote server, whereon the price is stored in association with a dealer record corresponding to the vehicle for which the price is being updated; communicating with a transmitter connected to the remote server and transmitting the updated price from the transmitter connected to the remote server to a receiver associated with the vehicle in the dealer inventory for which the price is to be updated; receiving the updated price by the receiver associated with the vehicle in the dealer inventory for which the price is to updated; and displaying the price on a display screen associated with and in communication with the receiver.

In another aspect, there is provided a system for vehicle inventory management comprises: a client device; a data center comprising a processor, memory, and one or more of an application module; a remote server connected to a transmitter; and a plurality of receivers, each receiver associated with a vehicle within a vehicle inventory floorplan of a dealership and wherein the receivers are arranged as a network, and in one embodiment as a mesh topography, relay, or hub and spoke topography; the system configured for sending a vehicle verification request via the client device to the data center for processing, whereby processing comprises transmitting the verification request from the transmitter to the plurality of receivers over a wireless communication network, and verifying the presence of a requested vehicle in the vehicle inventory upon retrieval of vehicle information associated with the requested vehicle of the vehicle verification request by the receiver, and subsequent transmission of vehicle information of the requested vehicle to the data center

In one embodiment the system and method operates in an exemplary network environment including one or more of a client device, one or more of a server, wherein the device and server communicate wirelessly over a LAN or WAN network. In one embodiment, the client device comprises a laptop computer, desktop computer, a tablet, a smartphone, or other suitable device. In one embodiment, the server is a server device connected to the client via a LAN or WAN, or also a cloud server.

### BRIEF DESCRIPTION OF THE DRAWINGS

Embodiments of the invention are further described hereinafter with reference to the accompanying drawings, in which:

FIG. 1 shows an overview of an exemplary system according to one embodiment of the present invention.

FIG. 2 shows an overview of a process for remotely updating the price associated with an electronic price tag of a vehicle, according to one embodiment of the present invention.

FIG. 3 shows an overview of an exemplary system and process for remotely updating the price of an electronic price tag associated with a vehicle, according to one embodiment of the present invention.

FIGS. 4A-C show screenshots of a mobile device configured with a mobile application in accordance with various embodiments of the present invention.

FIG. 5 shows a system for remotely updating a vehicle price according to one embodiment of the invention.

### DETAILED DESCRIPTION OF THE INVENTION

In one embodiment, the request originates from the user's end through an interface provided on a web portal or a mobile application. In one embodiment, the system is configured so that a user must provide one or more of a log-in credential to enter the system and initiate a request. In one embodiment, the request is transmitted to one or more of a web servers in a cloud-based datacenter via an http/https protocol (internet). An application server of the data center then instructs the system to route the request to a dealer server, also referred to as a “remote server”, based on the details in the incoming request. In another embodiment, the request is received on the dealer's server, and a transmitter associated with the server is triggered. In one embodiment, the transmitter is configured as a base station that communicates with a plurality of receivers. The receiver, or receiver base station, may be hardwired, or connected to the server through a Wi-Fi network, or other configurations as known in the art, such as Zigbee. In one embodiment, the transmitter/base station sends a signal wirelessly to the plurality of receivers associated with vehicle inventory, in order to verify an asset in an inventory floor plan. In another embodiment, the receivers that receive this request from the transmitter are all connected in a wireless software-driven network that enables the receivers to communicate with the transmitter in order to exchange data, gather data, and compose a response to the request with all of the inventory details and/or associated data that has been requested in the initial response. In another embodiment receivers are configured with an electronic display for display of a vehicle price, such as the Manufacturers Suggested Retail Price (MSRP) or Dealer Price (DP) associated with the vehicle.

In one embodiment, the system is comprised of hardware devices, including but not necessarily limited to one or more of a transmitter device and one or more of a receiver device, wherein the transmitter device and receiver device are configured to communicate with each other over a network, such as a wireless network. In one embodiment, the transmitter device is configured to recognize an incoming request, such as a request sent via communications over the internet. In another embodiment, the transmitter is configured to initiate and send a request out to a plurality of receiver devices connected in a wireless software network (configured to relay data along the network). In one embodiment, in the software network, one or more wireless (receiver) devices can be connected through other wireless receivers and can have a plurality of communication paths. In yet another embodiment, the transmitter is configured to communicate, to receive, to process, and to correlate the responses sent by return from one or more receivers in the plurality of receivers in the wireless software network, in response to the requests that had been sent out from the requesting transmitter.

In one embodiment, a plurality of receiver devices is arranged and implemented in a wireless software network; in which each node (receiver) of the network relays data for the network. All nodes cooperate in the distribution of data in the network and relay the communication of data associated with the inventory objects to/from the transmitter. In another embodiment, a receiver is associated with each inventory object of an inventory, and is configured to process, to store, and to communicate data regarding the inventory object to one or more of a transmitter associated with the system. In yet another embodiment, the receiver is configured to receive, to transmit, and communicate responses to one or more requesting transmitters.

In one embodiment, the system comprises a mobile application configured for execution on a client device. In one embodiment, the client device is a laptop computer, a desktop computer, a tablet computer, a smartphone or other portable electronic device, the device capable of wireless communications and data processing. In another embodiment there is provided a non-transitory computer-readable medium having recorded thereon a program that causes a portable device to execute the process and method described herein.

In one embodiment, a method for verifying the presence or absence of an inventory object (asset) in the inventory or the internal diagnostic details, comprises: sending a request from a client device asking to verify the presence of an inventory object at a site remote from the client device; receiving the request at a data center connected to transmission system of a floor plan inventory; transmitting the request amongst one or more of receivers connected in a network, wherein the software network is distributed amongst inventory objects of the inventory; verifying the presence of the inventory object and its diagnostic details by receiving a responsive transmission from the receiver connected to the inventory object; compiling a data set regarding inventory object details and geo-location of the object, and delivering the list of inventory object details matching the request to the client device initiating the inventory object verification request.

In one embodiment, a method for verifying the presence or absence of a specific inventory object within a greater inventory of objects, comprises: sending a request from a transmitter device in response to a user request to verify the presence of a specific object, at a site remote from the user; transmitting the request out amongst a plurality of receivers connected in a wireless software network, wherein this network is distributed amongst all objects of the inventory and the receivers are physically associated with the objects; verifying the presence of the object by receiving a responsive transmission from the receiver connected to the inventory object; compiling a data set regarding inventory object details and geo-location of the object, and delivering the list of inventory object details matching the request to the transmitter.

In one embodiment, a system for verifying the presence of a specific inventory object within an inventory floor plan comprises: a portable device configured with a user interface for initiating a request to verify the specific inventory object; one or more of a transmitter device for communicating requests to verify the specific inventory to a third party in control of the inventory floor plan; a plurality of receivers associated with inventory objects of an inventory and arranged in a wireless software network and in communication with the one or more transmitter devices, whereby the receivers are configured to communicate amongst the software network to verify the presence of the specific inventory object and to return one or more of identifying details about the inventory object for delivery to the portable device configured for initiating the request.

In one embodiment, the verification process is web-enabled. In one embodiment, the request for verification includes key parameters, such as dealer identification, bank identification, passwords, and other optional fields, such as a single-object verification versus all inventory verification. In one embodiment, the system routes a request from a verifying source, such as a Dealer, third party inventory manager or financial institution, to a signal transmitter at an automobile dealership. In one embodiment, a signal is then transmitted to all receivers or to a specific receiver connected to each inventory object. In another embodiment, the receivers are connected and configured for enabling the network to overcome any network issues/latencies and respond back to a verification request in a timely manner. In another embodiment, the receivers in the inventory objects are connected to the object's OBD (On-Board Diagnostics) port to gather details, such as vehicle identification number (VIN), fuel and battery levels, transmission issues, engine problems, etc. and uses the on-board GPS Chip in order to geo-locate the object. In yet another embodiment, the receivers on the inventory objects communicate with each other and reply back with a list of objects in the inventory with VINs, their internal details, their location coordinates, etc, in order to verify the inventory floor plan.

In one embodiment, a process for remotely updating a vehicle purchase price electronically displayed on an electronic tag associated with a vehicle, comprises sending a request to update a vehicle purchase price electronically displayed on an electronic tag associated with a vehicle, the request comprising a vehicle identifier and a value, wherein the value corresponds to the purchase price of the vehicle—wherein the request is sent from an electronic device in wireless communication with a dealer server; receiving the request at the dealer server; broadcasting the request from a transmitter connected with the dealer server to one or more of a receiver associated with a vehicle; and upon receiving the request by the receiver associated with the vehicle identifier in the request, updating the vehicle purchase price electronically displayed on the display of an electronic tag connected to the receiver.

In another embodiment, the process further comprises communicating with a device connected to the on board diagnostic system of the vehicle in order to receive vehicle information, including diagnostic information and geo location information of the vehicle, and transmitting vehicle information received from the on board diagnostic system from the vehicle to the dealer server.

In another embodiment, the process further comprises one or more receivers are connected in a mesh network configured for permitting multiple paths to traverse a network of connected vehicles in order to connect to the vehicle associated with the vehicle identifier of the request.

Attention is now drawn to the Figures, which show various embodiments of the invention. The figures are illustrative, but not exhaustive.

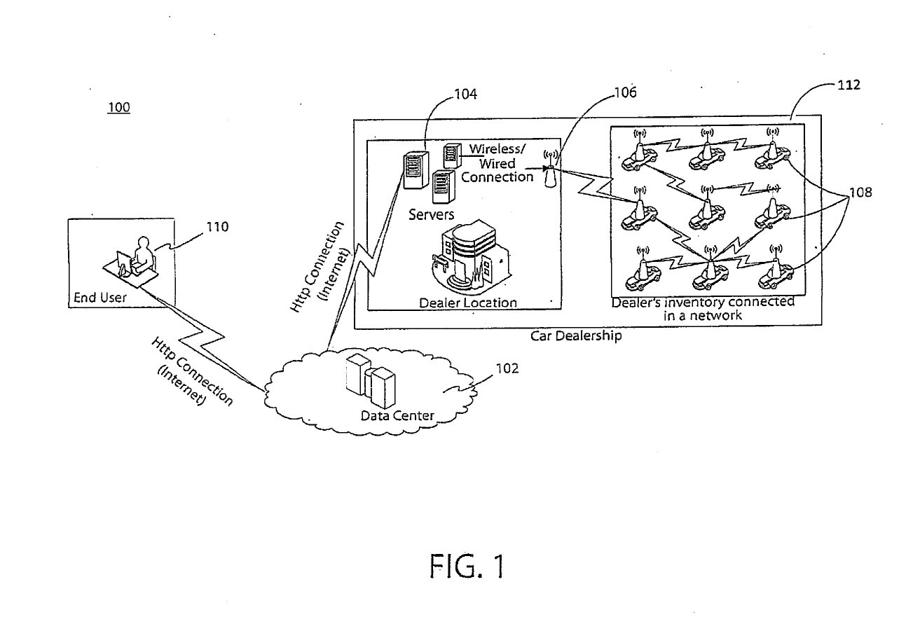

FIG. 1 shows an overview of an inventory verification and price update system 100, comprising a data center 102 in communication with one or more of a server 104, the server configured for connection to one or more of a transmitter 106, the transmitter in communication with a plurality of receivers 108, wherein each receiver is associated with a vehicle in a vehicle inventory 112, the data center configured to receive a request for vehicle data from a client device 110 and route the request by wireless communication from transmitter 106 to the plurality of receivers 108, in order to retrieve vehicle data from the receiver associated with a particular vehicle designated in the request. System 100 is configured to allow a user to remotely verify the floorplan inventory of an automotive dealership, and to retrieve particular data associated with an item of inventory.

Request is meant to include: a request to update, modify or change a value displayed on an electronic price tag associated with a vehicle, such as updating the MSRP or dealer price for the vehicle; a request to confirm a vehicle as part of a vehicle inventory; a request to retrieve vehicle data, including but not limited to: VIN, mileage, make of vehicle, model, year, MSRP; and a request to retrieve data from the on-board diagnostics system of the vehicle.

Data center 102 comprises one or more processing units, one or more of an application server, and memory. In another embodiment, the data center comprises communication means for communication with a client device and one or more dealer (remote) servers. In one embodiment, data center communicates via a wired or wireless connection. In another embodiment, data center comprises access via a web-based portal utilizing an http-protocol. In another embodiment, data center is further configured with one or more of an API for processing requests, such as processing carried out by an application server.

In one embodiment, the application server associated with data center may include one or more applications for processing requests. In one embodiment, an inventory verification application is a software application that includes instructions that when executed allow a portable device to remotely verify a vehicle in a dealer inventory, as further disclosed herein. In another embodiment, application server comprises an application for customer-facing processes to accept the request, display the response received upon processing, and response containing the inventory details; an application for processing the request, routing it to the dealership inventory to retrieve information related to one or more vehicles in question; and second application to correlate the responses received related to one or more vehicles in inventory with appropriate requests.

Memory represents a computer-readable medium capable of storing instructions, that when accessed by the processor, result in the processor performing as described herein. Memory may include any type of suitable memory or memory device. For example, memory may include volatile memory such as static random access memory (SRAM), or nonvolatile memory such as FLASH memory. Memory is encoded with (or has stored therein) one or more software modules, that when accessed by processor, result in processor performing various functions. In some embodiments, the software modules stored in memory may include an operating system (OS) and applications, including but not limited to an analytics application.

Dealer server 104 may be a server residing on-site at an automotive dealership, or may be a cloud-based server. Server 104 may be connected to transmitter 106 via a wired or wireless connection. Dealer server is also referred to as remote server, in that the server need not be physically located or in geographic proximity with the client device, or the user initiating the request, and to indicate that the server is associated with (in communication with) a dealership, which may be remote from the user, and may be remote from the dealership.

The system is configured to receive a request from client device 110. In one embodiment, the client device is a laptop computer, desktop computer, tablet, smartphone, or other portable electronic device configured with a connection, via http or other suitable protocol, to data center 102. Requests received by the data center are routed to the appropriate dealer server, where the request is then forwarded from the server to the transmitter associated with dealer server, and broadcast to the network of receivers associated with the dealer inventory.

In one embodiment, receiver 108 may be in connection with the on-board diagnostic system of the vehicle to which the receiver is associated. In one embodiment, an OBD device is configured with a wireless chip to communicate with an access point, or central hub, to aggregate the responses received from the receivers, before relaying a response to the transmitter. In another embodiment, a receiver may be configured with GPS capabilities. In yet another embodiment, the receiver is configured as an electronic device, comprising communication means for receiving a request from one or more of a transmitter from which requests are broadcast; a memory; a display screen; and means for displaying a value representing the retail price or MSRP of the vehicle.

In one embodiment, a receiver is configured as a device comprising a processor, a memory, a display screen and means of electronic display, communication means, such as Wi-Fi or cellular radio, and/or near field communications (NFC) radio. In one embodiment, the receivers are arranged for communication with each other and to a base station, and may be arranged as a network or network topography, including but not limited to a mesh topography, relay, or hub and spoke topography

In one embodiment, receiver comprises an electronic price tag. In one embodiment the electronic tag is configured for communication with the OBD system of the vehicle to which the receiver is assigned. In another embodiment, receiver comprises memory on which instructions are stored, for example instructions for processing vehicle data and data collected from the OBD. In yet another embodiment, receiver is configured with a display screen, such as an LCD screen for display of vehicle data, such as vehicle price, or statistics from the OBD, such as battery level; oil level; mileage; maintenance alerts, other internal diagnostic data, and the like.

Receiver 108 responds to the request by sending data related to vehicle inventory for the vehicle to which the receiver is associated, including one or more internal diagnostic details and the geo-location of the vehicle. In one embodiment, the response includes geo-coordinate data relating to the location of the vehicle; data retrieved from the OBD; or other data associated with the tag, such as a price of the vehicle, VIN, mileage, make or model, tire pressure, fuel level, engine failure or electrical failure messages that are available through the OBD of the vehicle.

In one embodiment, receivers are connected to the transmitter wirelessly using an electronic self-healing network connection that has capability to route through multiple paths to traverse the entire connected network of objects that enables multiple vehicles to communicate with and reply back to the request of the transmitter with the details requested.

Transmitter 106 relays the data from the receivers to the dealer-associated server 104, where it may be temporarily be stored in an electronic record before it is relayed on to the server. In one embodiment, transmitter is configured with communications means, for communicating with the plurality of receivers, such as Wi-Fi or cellular radio, and/or near field communications (NFC) radio.

In one embodiment, client device 110 is a user device, such as portable electronic device whereon an inventory verification and management application is installed. The device includes a processor, a memory, a display controller, communication means, such as Wi-Fi or cellular radio, and/or near field communications (NFC) radio. The portable electronic device may be a cell phone, a smartphone, a tablet computer, a laptop computer, or the like. The processor may be any type of processor capable of executing instructions stored in memory and capable of interfacing with the various components shown in FIG. 1. The display controller provides means for user input, such as sending a verification request, selecting a dealership from a list of dealerships, or access a user portal of the vehicle inventory management system.

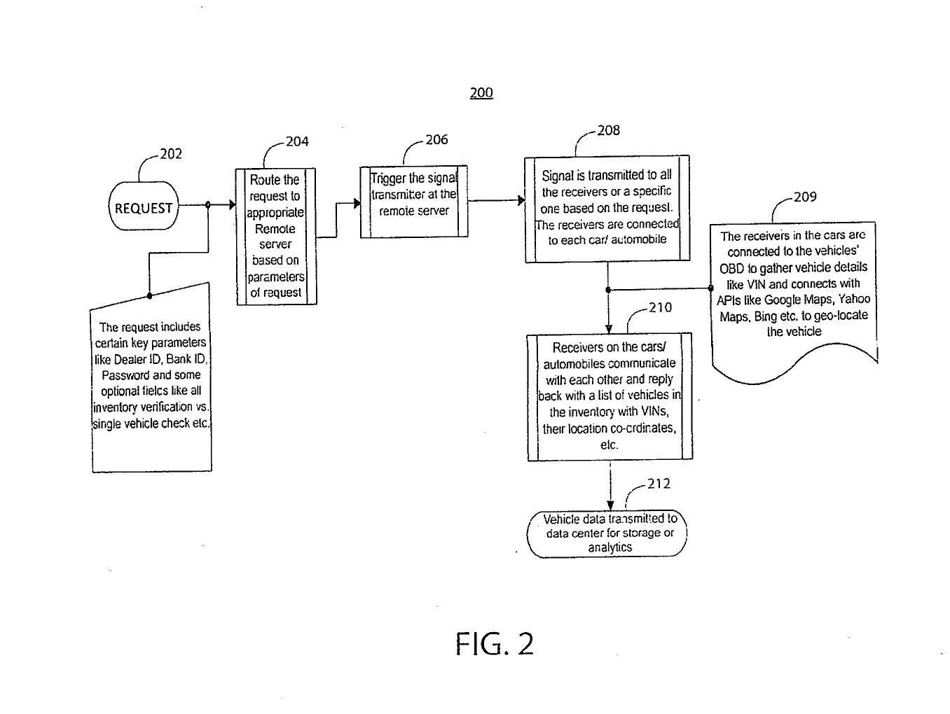

FIG. 2 shows an overview of a process for submitting a request to an electronic price tag of a vehicle 200, according to one exemplary embodiment of the invention. At step 202 a request is received from a user on a portable electronic device and sent wirelessly to a data center where, based on parameters identified by the user, the request is routed at step 204 to the appropriate dealer (remote) server. At step 206, the dealer server triggers the server-associated transmitter, which in turn transmits at step 208 the request from the transmitter to a plurality of receivers 208 associated with inventory at the dealership. The network of receivers are configured to enable the network to overcome any network latencies and respond to requests in real-time. The receivers may also be connected to the respective vehicles OBD (step 209) in order to gather vehicle data, such as VIN; receivers also are configured to connect with APIs of mapping programs, such as google maps, in order to geo-located the vehicle. The network of receivers communicate amongst one another at step 210 and reply back with the details requested of the particular vehicle or vehicles identified in the request parameters. The data center then confirms that the verification request has been satisfied by communicating the vehicle data back to the user device at step 212, and the data center may store data associated with the request on me memory associated with data center and for future processing by application modules associated with the data center.

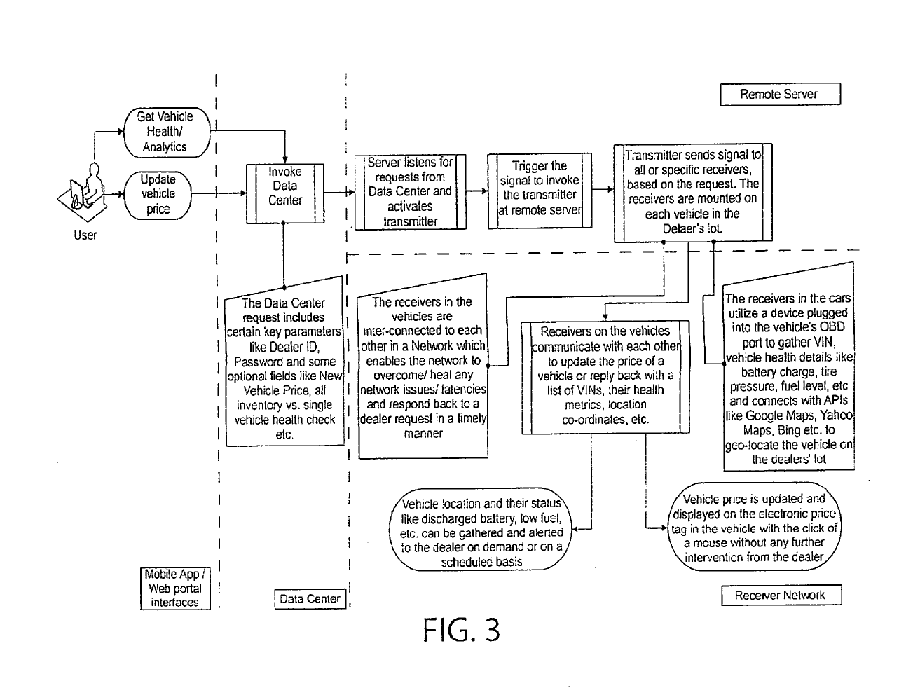

FIG. 3 shows an exemplary system and process for remotely updating a vehicle price displayed on an electronic price tag associated with a vehicle in a dealer inventory.

A request is initiated by a user by logging into a portal or a mobile application with a unique ID and password. The user then initiates a request for an individual vehicle, a set of vehicles, or the whole inventory of vehicles.

In one embodiment, the request from the user portal would contain some key parameters, including but not limited to: Dealer ID, Password, type of request, price of vehicle, and may include optional fields such as the make and model of vehicle.

In one embodiment, the request from the user's portal is transmitted to a data center and one or more servers of the data center, whereby the request is sent via internet protocol from the user portal to the data center.

In one embodiment, the data center comprises a processing unit on which resides an application module that is initiated upon receipt of the request by the data center and instructs the data center server to route the request to a dealer server located at the dealership.

In one embodiment, the dealer server connects to the server-associated transmitter through a wired or wireless connection and sends the details about the user request to the transmitter.

In one embodiment, the transmitter would send the request to the appropriate vehicles, such as those vehicles that need to verified, or that need a price update, or to all of the inventory that needs to be verified based on the parameters specified in the user's request.

In one embodiment, a plurality of receivers are connected to the vehicles in the dealer lot (one receiver per vehicle), and actively listening for user request transmissions from the transmitter.

In one embodiment, the plurality of receivers are wirelessly connected to the transmitter utilizing an electronic self-healing network connection configured to route through multiple paths to traverse the entire connected network of receivers, thereby the receiver system is enabled for all of the vehicles to communicate with and reply back to the transmitter with any details requested by the user request.

In one embodiment, the plurality of receivers are configured such that each receiver is connected to a vehicles' onboard diagnostics (OBD) system to retrieve details like vehicle identification number (VIN), type of vehicle, mileage on the vehicle, battery, fuel levels, tire pressure, transmission failure messages etc. that are available through the OBD port on the vehicle. In another embodiment, the receivers relay the information from the OBD to the data center, whereby an analytics module utilizes data from the OBD to manage vehicle inventory and update a vehicle record with information received from the OBD.

In another embodiment, the plurality of receivers are configured with GPS capabilities in order to determine the location of the vehicle. In yet another embodiment, the plurality of receivers comprise an electronic price tag configured with an LCD display screen capable of displaying the price of the vehicle.

In one embodiment, the transmitter receives vehicle data from the receivers and relays the data to the data center, where the data may be stored or processed further by one or more analytic engines of the data center.

In one embodiment, the data center is configured to connect to a dealer data management system (DMS) to import vehicle data, such as but not limited to: price for the vehicle, days listed for sale, dealer lot physical floorplan, etc.

In one embodiment, the data center is configured to assemble and/or process the data received related to a vehicle inventory request. In one embodiment, the assembled or processed data may be presented in graphical format or tabular format, listing all of the details requested; and provided a geographic location of the vehicle by pinpointing the vehicles on the dealer's physical lot by transmitting assembled or processed data from data center to a user device configured with a display screen for visual display of graphical or tabulated vehicle data. In another embodiment, the data is presented to the user on a display screen of a portable device, such as the display of a laptop computer or a smartphone.

In one embodiment, a request is routed by the data center to a server associated with the dealership to a transmitter that is either connected to the server with a hardwire or wireless connection, such as Wi-Fi or Zigbee, and the like, and transmitted to the inventory lot at the dealership to a plurality of receivers at a dealer lot, wherein each receiver is associated with a specific vehicle. Each receiver collects data from the vehicle to which it is connected, including data from the OBD of the vehicle and geographic coordinates of the vehicle location. When the receivers receive the request transmitted by the transmitter, the receivers send the request to the electronic price tag, causing the electronic display on the price tag to be updated with the price sent in the request.

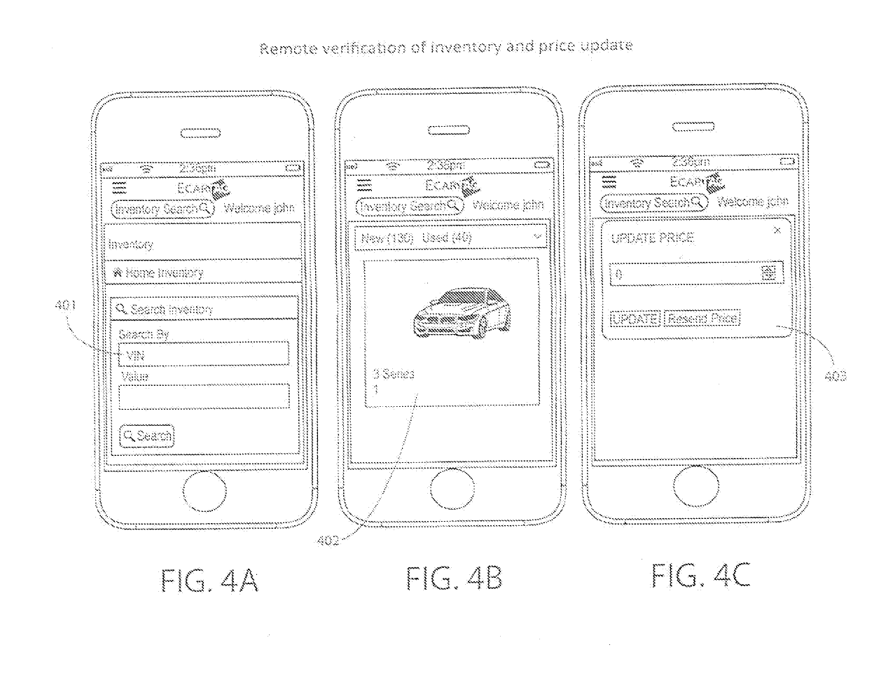

FIGS. 4A-4C show screenshots of a mobile device configured with a mobile application for remotely updating the price displayed on an electronic price tag of a vehicle, according to one embodiment of the present invention. FIG. 4A shows a search, wherein a search for a vehicle within a dealer inventory is based on input of a VIN into a search field 401 on a mobile device, wherein the VIN is input using a touch screen display of the mobile device. FIG. 4B shows a visual display 402 of a search result of a vehicle inventory of a dealership. FIG. 4C shows a display screen showing an input field 403 for updating a vehicle price, wherein an updated price may be entered into the input field and transferred from the device to the data center for further processing.

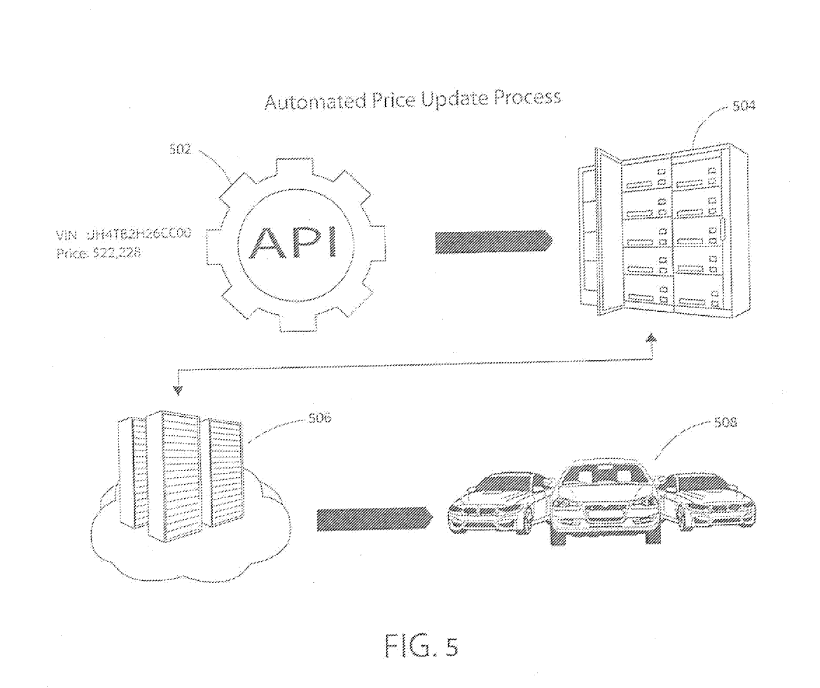

FIG. 5 shows a system 500 for remotely updating a price displayed on an electronic price tag of a vehicle, according to one embodiment of the invention. One or more of an API 502 customized for dealer-specific inventory is utilized to send pricing information associated with a particular VIN of a vehicle in a dealer inventory from a mobile device to data center 504, which in turn sends the pricing information to dealer server 506 associated with the dealership inventory. The pricing information is then communicated to and updated on the electronic tag 508 of the vehicle, thereby creating an electronic record of the updated price of the vehicle.

It will be clear to a person skilled in the art that features described in relation to any of the embodiments described above can be applicable interchangeably between the different embodiments. The embodiments described above are examples to illustrate various features of the invention.

Throughout this disclosure, the words “comprise” and “contain” and variations of them mean “including but not limited to”, and they are not intended to (and do not) exclude other components, integers or steps. Throughout the description, the singular encompasses the plural unless the context otherwise requires. In particular, where the indefinite article is used, the specification is to be understood as contemplating plurality as well as singularity, unless the context requires otherwise.

All of the features disclosed, and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed herein, or to any novel one, or any novel combination, of the steps of any method or process so disclosed.

We claim:

1. A process for remotely updating a vehicle purchase price using a portable electronic device, comprising:
sending a request to update a purchase price from the portable electronic device, the request comprising a vehicle identifier and a value, wherein the value corresponds to the purchase price of the vehicle, and wherein the request is sent from a portable device in wireless communication with a dealer server;
receiving the request sent from the portable device at the dealer server;
broadcasting the request from a transmitter connected to the dealer server to one or more of a receivers, wherein the receivers are each associated with a vehicle; and
upon receiving the request by the receiver associated with the vehicle identifier in the request,
updating the vehicle purchase price electronically displayed on a display of an electronic price tag connected to the receiver.

2. The process of claim 1, further comprising: communicating with a device connected to the on board diagnostic system of the vehicle in order to receive vehicle information, including diagnostic information and geo-location information of the vehicle, and transmitting vehicle information received from the on board diagnostic system from the vehicle to the dealer server.

3. The process of claim 1, wherein the one or more receivers are connected in a mesh network configured for permitting multiple paths to traverse a network of connected vehicles in order to connect to the vehicle associated with the vehicle identifier of the request.

4. The process of claim 1, wherein vehicle information comprises one or more of a vehicle identification number, vehicle price, make of vehicle, model of vehicle, mileage of vehicle, battery status, fuel consumption, oil level, fluid level, brake wear.

5. A system, comprising: a client device; a data center comprising a processor, memory, and one or more of an application module; a dealer server connected to a transmitter; and a plurality of receivers, each receiver comprising an electronic price tag configured with a display, and associated with a vehicle within a vehicle inventory of a dealership, and wherein the receivers are arranged as a network; the system configured for sending a request via the client device to the data center for processing, the request comprising a vehicle identifier and a value, wherein the value corresponds to the purchase price of the vehicle, and whereby processing comprises transmitting the request from the transmitter to the plurality of receivers over a wireless communication network, verifying the presence of a vehicle associated with the request, forwarding the value of the request to the transmitter, and updating the price displayed on the electronic price tag to reflect the value of the request.

6. A non-transitory computer-readable medium having recorded thereon a program that causes a portable device to execute a method for remotely updating a vehicle purchase price, wherein the purchase price is electronically displayed on an electronic tag associated with a vehicle, comprising: sending a request to update a vehicle purchase price electronically displayed on an electronic tag associated with a vehicle, the request comprising a vehicle identifier and a value, wherein the value corresponds to the purchase price of the vehicle and wherein the request is sent from an electronic device in wireless communication with a dealer server; receiving the request at the dealer server; broadcasting the request from a transmitter connected with the dealer server to one or more of a receiver in communication with the electronic tag associated with a vehicle; and upon receiving the request by the receiver associated with the vehicle identifier in the request, updating the vehicle purchase price electronically displayed on the display of an electronic tag connected to the receiver.
